(19) United States
(12) Patent Application Publication
(10) Pub. No.: US 2012/0057714 A1
(43) Pub. Date: Mar. 8, 2012

(54) Automatic Tunable Earphone And Method For Tuning The Same

(76) Inventor: You-Ruei Lin, Taipei (TW)

(21) Appl. No.: 12/874,230

(22) Filed: Sep. 2, 2010

(51) Int. Cl. H04R 29/00

(52) U.S. Cl. 381/59

(57) ABSTRACT

An automatic tunable earphone connected with an external audio device has an audio signal output unit, a loudspeaker, a microphone, a data memorizer and an arithmetic unit. The audio signal output unit outputs a testing audio signal into the loudspeaker for generating a testing sound which is transmitted into an ear canal. The microphone placed in the ear canal receives the sound that has past through the ear canal and outputs a contrastive audio signal into the data memorizer for restoring. The arithmetic unit compares the contrastive audio signal with the testing audio signal to find out the frequency that needs to be strengthened. The frequency is restored into the data memorizer. When the external audio device outputs a raw signal, the arithmetic unit process the raw signal according to the frequency restored and outputs the processed signal into the loudspeaker for making sound.

### BACKGROUND OF THE INVENTION

1. Field of the Invention

The present invention relates to an earphone, and particularly to an automatic tunable earphone and a method for tuning sound automatically.

2. The Related Art

Earphones are widely used in electrical products, such as CD player and walkman. A user can enjoy music with an earphone without affecting others. However, as the ear canal structure of different people is different, when the sound passes though the ear canal, the sound received by a listener will be different accordingly. Each person may feel a different sound effect when they are listening to the same music. In order to achieve the best sound effect, it is necessary to tune the sound according to different users. But the users can only adjust the playing equipment to control the volume and the tone quality. The earphone can not tune the sound. As a result, the earphone can not achieve the best sound effect. So, it is desirable to provide an earphone which can tune the sound according to the different ear canal structure to achieve the best sound effect.

### SUMMARY OF THE INVENTION

Accordingly, an object of the present invention is to provide an automatic tunable earphone connected with an external audio device and a method for tuning sound automatically. The automatic tunable earphone includes an audio signal output unit, a loudspeaker, a microphone, a data memorizer and an arithmetic unit. The audio signal output unit outputs a testing audio signal into the loudspeaker for generating a testing sound which is transmitted into an ear canal. The microphone placed in the ear canal receives the sound that has past through the ear canal and outputs a contrastive audio signal into the data memorizer for restoring the contrastive audio signal. The arithmetic unit compares the contrastive audio signal with the testing audio signal to find out the frequency that needs to be strengthened. The frequency is restored into the data memorizer. When the external audio device outputs a raw signal, the arithmetic unit process the raw signal according to the frequency restored and outputs the processed signal for playing.

The method for tuning sound automatically includes steps of: outputting a testing audio signal, generating a testing sound according to the testing audio signal, receiving the sound that has past through the ear canal and outputting a contrastive audio signal, restoring the contrastive audio signal, comparing the contrastive audio signal with the testing audio signal to find out the frequency that needs to be strengthened, restoring the frequency, processing a raw audio signal according to the frequency restored and outputting a processed signal, and then receiving the processed signal and making sound.

As described above, the automatic tunable earphone transmits a testing sound into the ear canal. As the sound performs differently according to different ear structures, the arithmetic unit finds out the frequency that needs to be strengthened by the mean of comparing the sound having past the ear canal with the testing sound. Then the arithmetic unit is able to process a raw sound according to the frequency. The whole tuning process is completed automatically without any manual operation. Also, the automatic tunable earphone can tune the sound according to different ear canal structures of people to have the best sound effect.

### BRIEF DESCRIPTION OF THE DRAWINGS

The present invention will be apparent to those skilled in the art by reading the following description thereof, with reference to the attached drawings, in which:

FIG. 1 is a flowchart showing a tuning principle of an automatic tunable earphone of an embodiment in accordance with the present invention;

FIG. 2 is a flowchart showing a setting parameters process of the tuning principle shown in FIG. 1;

FIG. 3 is a flowchart showing a playing sound process of the tuning principle shown in FIG. 1; and

FIG. 4 is a flowchart showing a process of a tuning sound method.

### DETAILED DESCRIPTION OF THE EMBODIMENT

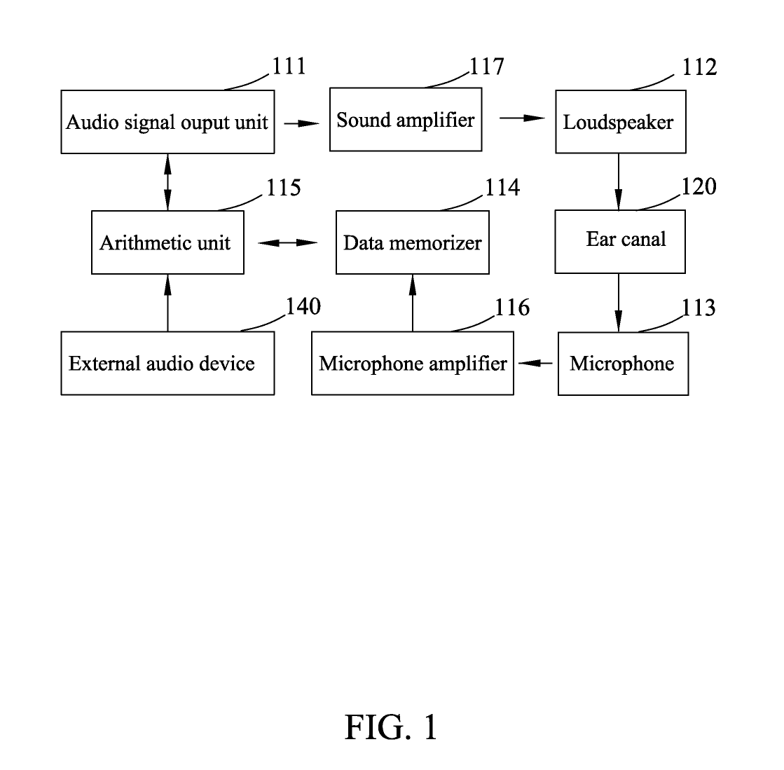

Referring to the drawings in greater detail, and first to FIG. 1, the embodiment of the invention is embodied in an automatic tunable earphone 1 connected with an external audio device 140. The automatic tunable earphone 1 includes an audio signal output unit 111, a loudspeaker 112, a microphone 113, a data memorizer 114, an arithmetic unit 115.

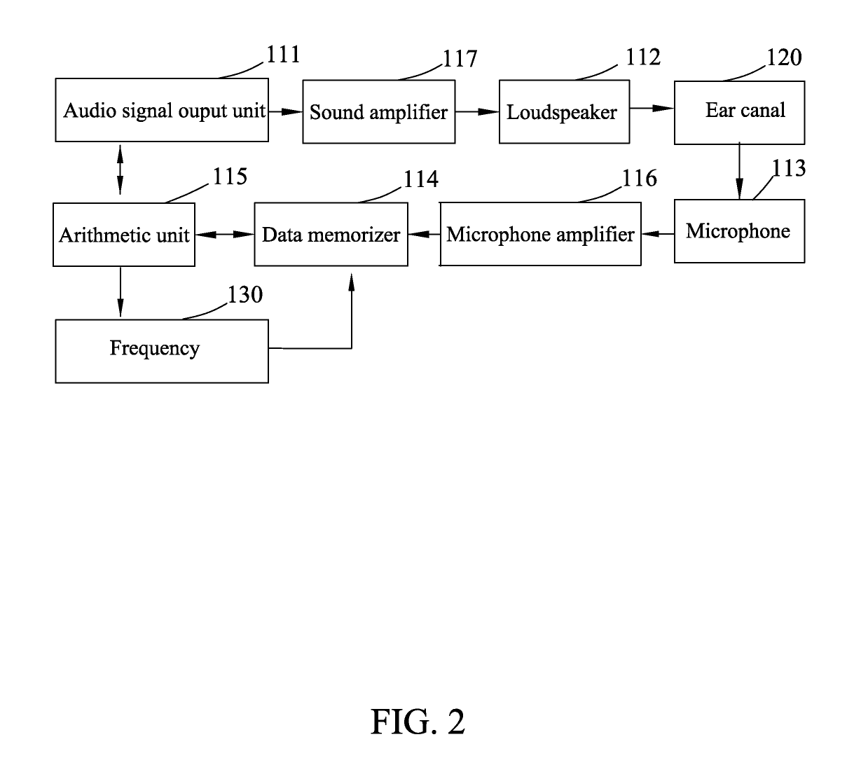

Referring to FIGS. 1-2, the audio signal output unit 1 generates a testing audio signal and outputs the testing audio signal into the loudspeaker 112 for making a testing sound. The testing sound is transmitted into the ear canal 120 and received by the microphone 113 which is placed in the ear canal 120. As the testing sound outputted by the loudspeaker 112 changes after passing through the ear canal 120, the sound received by the microphone 113 is different from the testing sound. The microphone 113 outputs a contrastive audio signal into the data memorizer 114 according to the sound received by the microphone 113. The arithmetic unit 115 reads the contrastive audio signal from the data memorizer 114 and makes a comparison between the testing audio signal and the contrastive audio signal. After comparison, the arithmetic unit 115 finds out the frequency 130 that needs to be strengthened and stores the frequency 130 in the data memorizer 114. When a raw audio signal is outputted by the external audio device 140, the arithmetic unit 115 processes the raw audio signal according to the frequency 130 stored in the data memorizer 114. The arithmetic unit 115 outputs the processed signal into the loudspeaker 112 by the audio signal output unit 111 for making sound.

In this embodiment, the automatic tunable earphone 1 further includes a microphone amplifier 116. The microphone amplifier 116 receives the contrastive audio signal outputted by the microphone 113 and amplifies the contrastive audio signal. After amplification, the contrastive audio signal is stored into the data memorizer 114. The automatic tunable earphone 1 further includes a signal amplifier 117 amplifying the signal outputted by the audio signal output unit 111 and outputting the amplified signal into the loudspeaker 112 to make sound.

Furthermore, the automatic tunable earphone 1 is able to detect if the automatic tunable earphone 1 is connected with an external device having an arithmetic function, such as a computer. If so, the automatic tunable earphone 1 cancels the connection with the arithmetic unit 115 and uses the external device to process the sound. If not, the automatic tunable earphone 1 uses the arithmetic unit 115 thereof to process the sound.

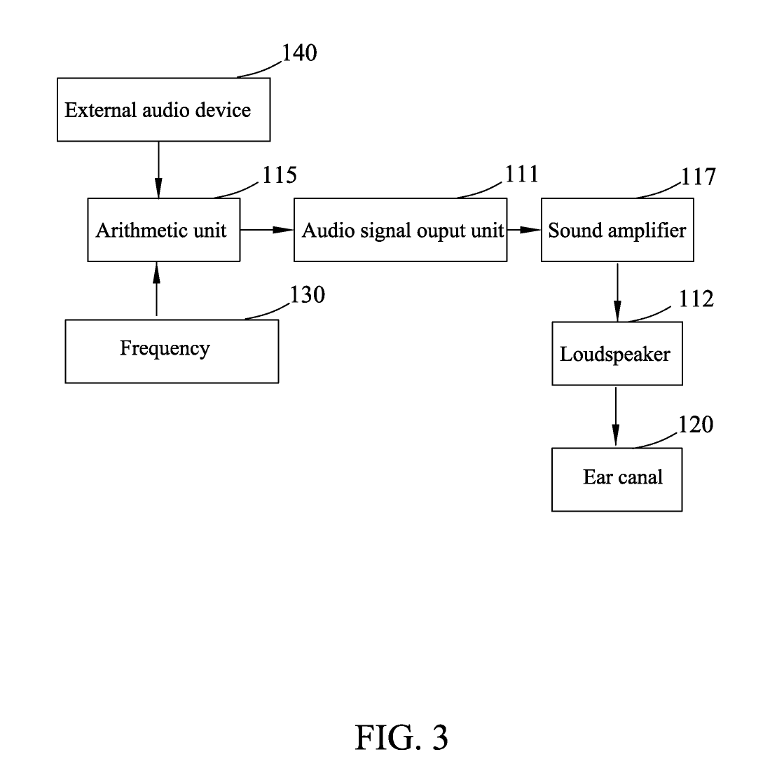

With reference to FIGS. 2-3, in practice, the automatic tunable earphone 1 detects if the automatic tunable earphone 1 is connected with an external device first. If so, the automatic tunable earphone 1 uses the external device to process the sound. If not, the automatic tunable earphone 1 uses the arithmetic unit 115 thereof to process the sound. The process of tuning sound is divided into a setting parameters process and a playing sound process. In the setting parameters process, the signal output unit 111 outputs a testing audio signal into the loudspeaker 112 which generates a testing sound. After passing through the ear canal 120, the testing sound changes and performs differently according to different ear structures of people. So, different people feel different although the testing sound is the same. The microphone 113 placed in the ear canal 120 receives the sound having past though the ear canal 120 and outputs a contrastive audio signal. The microphone amplifier 116 receives and amplifies the contrastive audio signal. The amplified contrastive audio signal is inputted into the data memorizer 114. The arithmetic unit 115 reads the contrastive audio signal from the data memorizer 114 and compares the contrastive audio signal with the testing audio signal. After comparison, the arithmetic unit 115 finds out the frequency 130 that needs to be strengthened and outputs the frequency 130 into the data memorizer 114. In the playing sound process, the external audio device 140 outputs a raw audio signal, then the arithmetic unit 115 processes the raw audio signal according to the frequncy 130 restored in the data memorizer 114. The processed audio signal is inputted into the sound amplifier 117 by the audio signal output unit 111 and amplified by the sound amplifier 117. The amplified audio signal is inputted into the loudspeaker 112 for making sound finally.

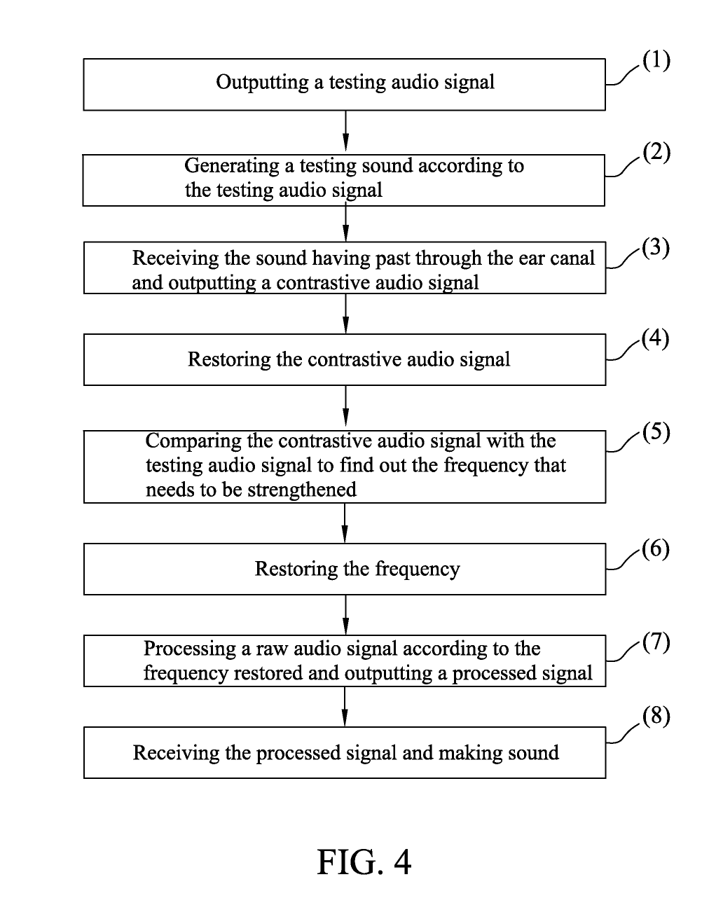

With reference to the FIG. 4, a method for tuning sound in an automatic tunable earphone 1 comprises steps of:
(1) Outputting a testing audio signal by the audio signal output unit 111;
(2) Generating a sound by loudspeaker 112 according to the testing audio signal;
(3) Receiving the sound having past through the ear canal and outputting a contrastive audio signal by the microphone 113;
(4) Restoring the contrastive audio signal in the data memorizer 114;
(5) Comparing the contrastive audio signal with the testing audio signal by the arithmetic unit 115 to find out the frequency that needs to be strengthened;
(6) Restoring the frequency in the data memorizer 114;
(7) Processing a raw audio signal by the arithmetic unit 115 according to the frequency restored;
(8) Receiving the processed signal and making sound by the loudspeaker 112.

In this embodiment, the step (4) further comprises a process amplifying the contrastive audio signal by the microphone amplifier 116 before restoring. The step (2) and step (8) further comprise a process amplifying the signal by the sound amplifier 117 before outputting the signal into the loudspeaker 112 for making sound.

As described above, the automatic tunable earphone 1 transmits a testing sound into the ear canal 120. As the sound performs differently according to different ear structures, the arithmetic unit 115 finds out the frequency 130 that needs to be strengthened by means of comparing the sound having past the ear canal 120 and the testing sound. Then the arithmetic unit 115 is able to process a raw sound according to the frequency 130. The whole tuning process is completed automatically without any manual operation. Also, the automatic tunable earphone 1 can tune the sound according to the different ear canal structure of people to have the best sound effect.

What is claimed is:

1. An automatic tunable earphone connected with an external audio device comprising an audio signal output unit for outputting a testing audio signal;
a loudspeaker for generating a testing sound according to the testing audio signal;
a microphone placed in an ear canal for receiving the sound having past through the ear canal and outputting a contrastive audio signal;
a data memorizer restoring the contrastive audio signal; and
an arithmetic unit comparing the contrastive audio signal with the testing audio signal, finding out the frequency that needs to be strengthened, and processing a raw sound outputted by the external audio device according to the frequency.

2. The automatic tunable earphone as claimed in claim 1, further comprising a microphone amplifier receiving the contrastive audio signal outputted by the microphone and amplifying the contrastive audio signal and then outputting the contrastive audio signal into the data memorizer.

3. The automatic tunable earphone as claimed in claim 1, further comprising a sound amplifier amplifying the signal outputted by the audio signal output unit and outputting the amplified signal into the loudspeaker for making sound.

4. A method for tuning sound comprising steps of:
(1) Outputting a testing audio signal;
(2) Generating a testing sound according to the testing audio signal;
(3) Receiving the sound that has past through the ear canal and outputting a contrastive audio signal;
(4) Restoring the contrastive audio signal;
(5) Comparing the contrastive audio signal with the testing audio signal to find out the frequency that needs to be strengthened;
(6) Restoring the frequency;
(7) Processing a raw audio signal according to the frequency restored and outputting a processed signal; and
(8) Receiving the processed signal and making sound.

5. The method as claimed in claim 4, wherein the step (4) further comprises a process amplifying the contrastive audio signal before restoring.

6. The method as claimed in claim 4, wherein the step (2) and step (8) respectively further comprising a process of amplifying the signal outputted by the audio signal output unit before making sound.
